(19) United States
(12) Patent Application Publication
(10) Pub. No.: US 2022/0311186 A1
(43) Pub. Date: Sep. 29, 2022

(54) COUPLING DEVICE

(71) Applicant: KRATZER AUTOMATION AG, Unterschleibheim (DE)

(72) Inventor: Juergen AUWEILER, Unterschleibheim (DE)

(73) Assignee: KRATZER AUTOMATION AG, Unterschleibheim (DE)

(21) Appl. No.: 17/701,281

(22) Filed: Mar. 22, 2022

(30) Foreign Application Priority Data
Mar. 23, 2021 (DE) 102021107209.3

(51) Int. Cl. H01R 13/635; H01R 13/62; H01R 13/627; H01R 13/637

(52) U.S. Cl. CPC H01R 13/635; H01R 13/6205; H01R 13/6271; H01R 13/637

(57) ABSTRACT

A coupling device (1) is provided with a first connection module (12) and a second connection module (14) releasably connectable to the first connection module (12). The first connection module (10) and the second connection module (14) form a connector (10). The coupling device (1) is adapted to apply a coupling force that creates a connection between the first connection module (12) and the second connection module (14), and to apply a decoupling force that releases the connection. The decoupling force and the coupling force are applied by the first connection module (12) to the second connection module (14), and the decoupling force counteracts the coupling force. The coupling force is provided by a pneumatic, hydraulic, electric, or electromagnetic actuator (20) provided on the first connection module (12). The decoupling force is provided by a mechanical, electrostatic, or magnetic storage device (24) capable of receiving, storing, and releasing a portion of the energy generated by the coupling force. The coupling force is provided by a coupling mechanism, and the decoupling force is provided by a decoupling mechanism. The decoupling mechanism forms a unit with the coupling mechanism.

### FIELD OF THE INVENTION

The present invention relates to a coupling device for a connector, such as a connector for electrical power transmission, and a coupling system comprising the same.

### PRIOR ART

Test rigs are commonly used to place various types of products under controlled conditions and perform tests. For example, various loads and load spectra are applied to the product at a test rig to reproduce the behavior of the product in daily use or in extreme situations. For products that receive or deliver high power, the test rig is usually located in a test rig space set up separately for this purpose. Examples of such products include electric motors and their batteries, hydraulic motors and their pumps or pressure accumulators, and pneumatic motors and their pressure accumulators. Depending on which products are being tested, a test rig space must have different supply and signal connections.

For example, if accumulators (battery cells, battery modules, battery packs) are to be tested in the test rig space, it is therefore necessary for the accumulators to be connected to a power supply. This is necessary to reproduce the charge/discharge load. Depending on the size and design of the accumulators, a power supply in the low-voltage range (up to 1500 V) is required. This applies in particular if the accumulators are used for electrically powered vehicles (for example BEV, PHEV). This usually requires a power supply into the test rig space that is designed for voltages up to 1500 V and currents up to 1000 A.

Since in corresponding test rig tests a large number of accumulators have to be tested one after the other and a large number of tests have to be performed, as usually each accumulator or battery pack has to be tested before being used in an electric vehicle, a large number of test rig spaces is necessary. In order to complete the loading of each test rig space with a test object in the shortest possible time, a coupling device is desirable for quickly coupling and decoupling the test object to and from the test rig.

In the prior art, various designs of coupling devices are known to date that provide a releasable coupling for power transmission, Examples include connectors for electrical power transmission and hose couplings for pneumatic or hydraulic power transmission. In conventional coupling devices, coupling and decoupling are performed manually or by an auxiliary force, for example by a pneumatic or hydraulic actuator.

When a conventional coupling device for a connector is combined with a mobile test object, the test object can be quickly brought into the test rig space and coupled, and quickly decoupled and removed after a test, Naturally, not all tests are successful, so in some cases smoke may be generated in the test rig space or a fire may occur. In such an emergency, an emergency stop device is triggered automatically or by a supervisor, which interrupts the power supply to the test object and activates a fire extinguishing or smoke extraction system, alerts safety personnel or triggers other appropriate measures as required.

In the event of an emergency, manually operated coupling devices require that safety personnel have access to the coupling device in addition to access to the test object in order to release the coupling and remove the test object. Auxiliary force-actuated coupling devices, on the other hand, require continued provision of the auxiliary force so that complete interruption of any power supply to the test rig is delayed or prevented. In addition, auxiliary force-actuated coupling devices can injure the assembler if inadvertently actuated during assembly or maintenance work. Accordingly, there is potential for improvement in terms of the ability to decouple the connection in a quick, reliable and automatable manner in an emergency. Further potential for improvement relates to safety during assembly work and testing, as well as the avoidance of downtime.

### SUMMARY OF THE INVENTION

In order to solve the foregoing problems, a coupling device according to the present invention is proposed.

The present disclosure provides a coupling device comprising a first connection module and a second connection module releasably connectable to the first connection module. The first connection module and the second connection module form a connector. The coupling device is adapted to apply a coupling force that creates a connection between the first connection module and the second connection module, and to apply a decoupling force that releases the connection. The decoupling force and the coupling force are applied by the first connection module to the second connection module, wherein the decoupling force counteracts the coupling force.

The coupling device according to the present invention has two connection modules to implement a connector. For example, the connector can be an electrical power transmission connector used at a test rig to couple or decouple test objects to or from the test rig space. In such a case, the connection modules are, for example, a combination of a socket module and a plug module. Alternatively, the connector may serve for hydraulic or pneumatic power transmission, the connection modules being hose couplings, for example. To connect or couple the connection modules to each other, a coupling force is applied from the first connection module, which is provided on the test rig side, to the second connection module, which is provided on the test object side. To release the coupling again and separate or decouple the connection modules from each other, a decoupling force is applied in the same way.

According to the invention, the decoupling force counteracts the coupling force. Thus, the coupling force must overcome the decoupling force to maintain the coupling. Therefore, when the coupling force is no longer applied, for example because an emergency stop device has been activated, the decoupling force can automatically release the coupling, thereby decoupling the second connection module (and thus the test object) from the first connection module (and thus the test rig). Accordingly, decoupling of the connector using the decoupling force can occur automatically as soon as the provision of the coupling force is interrupted.

As described above, either access to the connector or continued provision of an auxiliary force are required to disengage the coupling according to the prior art, in contrast, using the coupling device of the present invention, it is possible to initiate decoupling solely by interrupting the provision of the coupling force. Thus, decoupling by security personnel or by means of an auxiliary force is not required. This enables fast, reliable and automatable decoupling of the connector in an emergency, which improves emergency safety.

The coupling force is provided by a pneumatic, hydraulic, electric or electromagnetic actuator provided on the first connection module.

According to the invention, the provision of the coupling force can be realized by an actuator provided at the first connection module and thus at the test rig side, Therefore, the frequently replaced second connection module can have a simple structure, while the more complex structure for force provision is to be provided only once at the first connection module, which is fixedly connected to the test rig space. Furthermore, the aforementioned actuators are advantageous in terms of their controllability and they are inexpensive to procure.

If a pneumatic actuator is provided, the coupling force can be applied or withdrawn with short reaction times. Furthermore, a compressed air line is often already present in test rig spaces, so that the pneumatic actuator does not require a separate pump or other device to generate pressure. In such a case, a cost-effective structure is possible.

If a hydraulic actuator is provided, very high coupling forces can be applied. Since higher powers generally require larger connection modules and thus higher coupling forces, it is possible with a hydraulic actuator to implement connectors for the transmission of very high powers. In addition, hydraulic actuators have a low space requirement, which means that a space-saving structure is possible.

If an electric or electromagnetic actuator is provided, the structure is simplified in that no device for generating pressure is required, which also reduces the space requirement.

Furthermore, the provision of the coupling force can be coupled to the provision of power to the connector, so that the interruption of the power supply automatically also interrupts the provision of the coupling force. Thus, one shutdown operation is sufficient to interrupt the power supply to the test object as well as the provision of the coupling force and thus to enable the decoupling of the connection modules by means of the counteracting decoupling force. This further improves the emergency safety.

It is also possible to combine several operating principles of the actuator, for example an electromagnetically actuated actuator that generates a pneumatic force and releases the actuating pressure in the de-energized state, thus interrupting the force generation. Thus, the aforementioned advantages can be achieved in combination.

The decoupling force is provided by a mechanical, electrostatic or magnetic storage device that can receive, store and release a portion of the energy generated by the coupling force.

The storage device according to the above operating principles enables passive provision of the decoupling force. More specifically, the energy required for decoupling can already be applied and stored during the coupling process by the coupling force. Immediately after the interruption of the provision of the coupling force, this energy can be released again, so that the decoupling force can be applied in a completely passive manner for a sufficient duration to decouple the connection modules. Accordingly, the coupling device thus configured can perform decoupling passively and no additional auxiliary force or active provision of the decoupling force is required. Thus, the emergency safety is further improved.

If the storage device is a mechanical storage device, such as a spring, the structure is particularly cost-effective and reliable. Alternatively, the storage device can store potential energy in an electrostatic or magnetic manner by means of repulsive forces, for example, by providing like-charged plates or magnets with their like poles facing each other at each of the connection modules. Thus, the passive effect is achieved without wear.

The coupling force is provided by a coupling mechanism, and the decoupling force is provided by a decoupling mechanism that forms a unit with the coupling mechanism.

When the coupling mechanism and the decoupling mechanism are formed as one unit, they can be accommodated in a space-saving manner. Furthermore, the resulting unit can be pre-assembled in a cost-effective manner so that it can be quickly mounted or replaced on the test rig, for example, when the connector is being serviced or another connector is being mounted. This reduces downtime.

Alternatively, the coupling force can be provided by a coupling mechanism, and the decoupling force can be provided by a decoupling mechanism that is separate from the coupling mechanism.

Functionally separating the coupling mechanism from the decoupling mechanism further improves emergency safety. Further, the mechanisms can also be spatially separated according to the circumstances, allowing better use of the space available near the connector.

Preferably, the coupling force is provided by an operating mechanism that is different from the operating mechanism of the decoupling force.

The coupling force and the decoupling force can be provided by means of different operating mechanisms with different, independent power supplies, control devices and the like. An example is the combination of pneumatically provided coupling force (pneumatic actuator) and mechanically provided decoupling force (spring as passive storage device). By using different operating mechanisms, there is no interaction between the provision or interruption of the coupling force and the provision of the decoupling force. Accordingly, the decoupling force can be reliably provided or kept ready, further improving emergency safety.

In the preceding coupling device, the second connection module can have an engagement portion, and the first connection module can have an engagement unit cooperating with the engagement portion such that the engagement unit is movable between an alignment position in which the second connection module is aligned with the first connection module and is removable from the first connection module, and a locking position in which the second connection module is aligned with the first connection module and a removal of the second connection module from the first connection module is prevented.

According to the invention, the first connection module can include an engagement unit that engages and cooperates with an engagement portion of the second connection module to implement an aligned state and a locked state, wherein an alignment position of the engagement unit corresponds to the aligned state of the coupling device and a locking position of the engagement unit corresponds to the locked state of the coupling device. In the aligned state, the connection modules are aligned with each other while the second connection module is removable and no power transmission occurs. In the locked state, the connection modules are aligned while the second connection module is locked so that it cannot be removed from the first connection module in the decoupling direction. Alignment allows for easy and smooth coupling or decoupling. Locking ensures that the second connection module is not accidentally removed or falls off, thereby improving safety during assembly work on the test rig (assembly safety) and safety during test operation.

Preferably, there is no connection for power transmission in the alignment position and in the locking position. Thus, assembly work can be performed while the second connection module is locked to or aligned with the first connection module, but no power is supplied to the second connection module. This ensures and further improves the assembly safety.

Preferably, the engagement unit is further movable to a coupling position in which the engagement unit is engaged with the engagement portion and the coupling force is applied to the second connection module by the engagement to move the second connection module to a coupled position and hold it there so that there is a connection for power transmission.

The movement from the locking position to the coupling position establishes the connection for the power transmission. The result is a coupled state. Since the connection modules are properly aligned with each other, transitions from the locked state to the coupled state and back can be made quickly and unimpeded. Accordingly, the switching of the power transmission can occur quickly and unimpeded, and the emergency safety is further improved.

Preferably, the actuator is an electric or pressure operated swing clamp cylinder comprising a rod having at its distal end the engagement unit, and the engagement unit is rotatable by the swing clamp cylinder between the alignment position and the locking position and is axially displaceable between the locking position and the coupling position.

Swing clamp cylinders are components that are inexpensive to procure and can represent the functions required above in a space-saving manner. Thus, they are highly suitable for the coupling device of the present invention. The above advantages of the various types of actuators apply to the selection of the operating principle of the swing clamp cylinder. For example, an electric swing clamp cylinder can be implemented by means of an electrically operated threaded rod for axial movement and an electrically operated device for rotation, whereby it can be connected particularly favorably to any electric power transmission of the connector, A pressure operated (pneumatic or hydraulic) swing clamp cylinder can be implemented, for example, by applying pressure to a piston in a pressure cylinder to axially displace a rod. In this case, a suitable device can be provided to generate a rotation simultaneously to the axial movement or at its end. An example of such a device is a helical groove in the rod and a stationary pin on the pressure cylinder, wherein the pin engages the groove. With such a configuration, the axial movement is used to induce a rotation.

Regardless of the method of actuation of the swing clamp cylinder, the engagement portion preferably performs a corresponding rotation from the alignment position to the locking position, as well as an axial movement from the locking position to the coupling position. Thus, by a single actuation of the swing clamp cylinder, the engagement portion can pass through all three positions in a suitable sequence to perform the coupling. Thus, the coupling is performed quickly.

Preferably, the storage device is a spring that is relaxed or preloaded in the alignment position and tensioned in the coupling position.

Springs are low-wear, cost-effective components that can store and release energy with high efficiency. As a result, a simple and cost-effective structure is implemented. Preferably, the spring is preloaded in the alignment position to compensate for sliding friction losses on the way from the alignment position to the coupling position. Alternatively, the spring can be relaxed in the alignment position to minimize the forces to be applied by the actuator.

Preferably, the storage device and the actuator are adapted so that the energy output of the storage device or the relaxation of the spring causes a movement of the engagement unit from the coupling position via the locking position to the alignment position.

With the above structure, all the decoupling steps can be performed in a passive manner. Thus, a simple and cost-effective structure is provided, and the safety and reliability of the decoupling are improved.

Preferably, the foregoing coupling device is further provided with a guiding device for aligning the second connection module with the first connection module.

Providing a guiding device eliminates the need for manual alignment, thereby reducing the possibility of errors and downtime.

Preferably, the guiding device comprises a support plate provided on the first connection module and a support projection provided on the second connection module. Here, the support projection rests on the support plate in the alignment position to align the second connection module with the first connection module.

If the support plate is horizontal or nearly horizontal, the dead weight of the second connection module is used to align it with the first connection module in the height direction. If the support plate is vertical or nearly vertical, the second connection module is aligned with the first connection module in the horizontal plane. In both cases, the alignment is achieved with a simple structure. Furthermore, the alignment can be improved by having multiple support plates in different planes.

Alternatively or additionally, the guiding device can comprise a guiding hole provided on the first connection module and a guiding pin provided on the second connection module. The guiding hole and the guiding pin are adapted to guide the second connection module between the locking position and the coupling position relative to the first connection module so that the aligned connection modules are movable in the coupling direction.

With the above structure, a better and reliable alignment is achieved also during the coupling process by simple, cost-effective means. In addition, the ease of movement and, accordingly, the decoupling safety are improved.

In the above coupling device, the first connection module and the second connection module can be adapted to transmit electrical power and/or transmit an electrical signal and/or transmit a pressurized fluid.

With the foregoing structure, one or more transmissions can be provided in a connector, wherein a common coupling device can couple and decouple the transmission/transmissions. This unifies the structure of the coupling device on the test rig side despite different transmissions, thereby improving the flexibility in the use of a test rig space. Downtime is reduced due to flexible replacement of connection modules without modification to the coupling device.

The coupling device described above can be provided in a coupling system that further includes an emergency stop device that is adapted to interrupt the provision of power to the first connection module and to interrupt the pressure supply or energy supply to the actuator when actuated.

With the above coupling system, a single actuation of an emergency stop device causes the test rig to shut down while decoupling the connector. This further improves the emergency safety.

The above coupling system can include a first switch that switches the provision of power to the first connection module and a second switch that switches the pressure supply or energy supply to the actuator.

The first switch can activate and deactivate the power supply, while the second switch can use control of the actuator to control the provision of the coupling force and thus the coupling and decoupling, Hence, the operations for coupling/decoupling and for providing/interrupting power transmission are independent of each other. Accordingly, the test object can be coupled to the test rig without supplying power to it, which improves the assembly safety. Furthermore, in test mode, the power can be switched on and off by both switches as needed, for example, only the first switch can be actuated during the test, while the second switch is actuated at the start and end of the test. This ensures that the test object is not supplied with power outside the test times, so that even unintentional actuation of the first switch during assembly work does not result in any danger for the assembler. Accordingly, the assembly safety is improved.

In the above coupling system, the coupling device can be provided inside a test rig space, the first switch can be provided outside the test rig space, and the second switch can be provided so as to be operable to turn off the pressure supply or energy supply from outside the test rig space and operable to turn on the pressure supply or energy supply from inside the test rig space.

With the above coupling system, the assembler can initiate the switching on of the pressure supply/energy supply, and thus the coupling, after ensuring that the test object is properly housed in the test rig space and that all safety precautions have been taken. This improves the assembly safety. Also advantageously, the second switch can be arranged such that the assembler cannot operate the second switch while touching the second connection module. This prevents the assembler from being trapped or pinched by the coupling device. On the other hand, switching off the pressure supply/energy supply, and thus decoupling, can also be performed from outside the test rig space. Therefore, in an emergency, a supervisor can operate the first switch and the second switch separately or together to interrupt the power transmission to the test object and decouple the connector with a time delay or simultaneously. An operation of the second switch by safety personnel in the test rig space is not required. This further improves the emergency safety.

### BRIEF DESCRIPTION OF THE DRAWINGS

FIG. 1 shows a perspective view of a coupling device according to the invention in an aligned state.

FIG. 2 shows a perspective view of the coupling device in a coupled state.

FIG. 3 shows a front view of the coupling device in the aligned state.

FIG. 4 shows a front view of the coupling device in a locked state.

FIG. 5 shows a top view of the coupling device in an initial state.

FIG. 6 shows a top view of the coupling device in the coupled state,

FIG. 7 shows a side view corresponding to FIG. 5.

FIG. 8 shows a side view corresponding to FIG. 6.

FIG. 9 shows a coupling system with a test rig space and the coupling device according to the invention.

FIG. 10A shows a schematic illustration of the coupling device according to the invention.

FIG. 10B shows a first modification of the coupling device,

FIG. 10C shows a second modification of the coupling device.

FIG. 10D shows a third modification of the coupling device.

### DETAILED DESCRIPTION OF THE EMBODIMENT

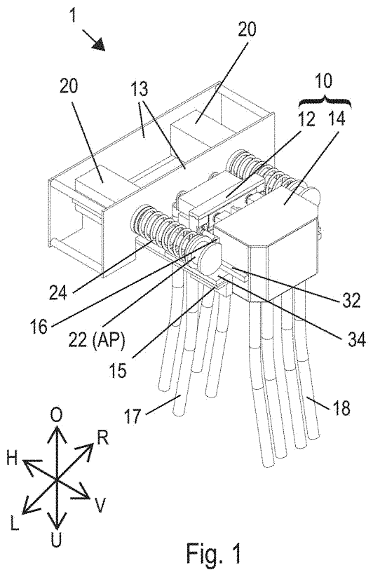

In FIGS. 1 to 8, an embodiment of a coupling device according to the invention is shown. A coupling device 1 according to the embodiment is provided on a wall not shown in a test rig space 52 to couple a battery pack as a test object 60 to the test rig space 52 and to enable a test operation.

Directional indications in the following description are determined with reference to a normal direction of the wall to which the coupling device 1 is attached, and to a direction of gravity, A left-right direction is the direction perpendicular to both the normal direction and the gravity direction. An object or geometry element that is far from the wall in the normal direction is referred to as “front”; a geometry element close to the wall is referred to as “rear”, “Top” and “bottom” refer to the direction of gravity. The terms “left” and “right” are determined when viewed from the front (that is, looking at the wall viewed from inside the test rig space along the normal direction). For clarity, directional arrows are shown in FIGS. 1 to 8 and are labeled O=top, U=bottom, L=left, R=right, V=front, and H=rear. In the embodiment, the normal direction is also the coupling direction along which a coupling process described later is performed.

Connection Modules

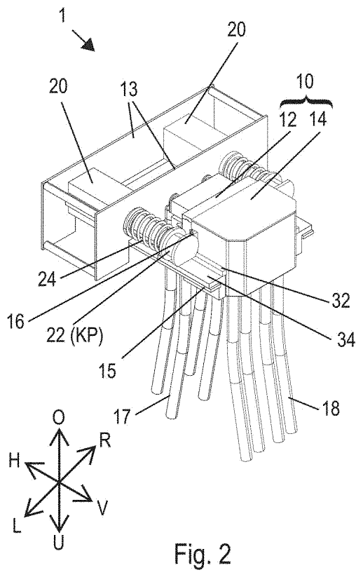

The coupling device 1 shown in FIGS. 1 and 2 has a power connector 10 for transmitting power, which serves as a connector and has a first connection module 12 and a second connection module 14.

In the embodiment, the first connection module 12 has a socket module that provides power (electrical power) for the test operation. The socket module is substantially a metal plate with one or more connection sockets provided thereon. The connection sockets are preferably modularly interchangeable so that they can selectively provide and transmit power or pressurized fluids depending on the requirements of the test object 60 or the test to be performed. The first connection module 12 further has a frame 13 attached to the wall of the test rig space 52. In the embodiment, the frame 13 is formed as two parallel plates with a plurality of spacers, one of which is attached to the wall and the other of which is spaced from the wall at a certain distance. Two actuators 20 described later are arranged between the plates of the frame 13. In the embodiment, the frame 13 further has two symmetrically arranged protrusions 15 which support the socket module from below. The socket module can be removed from the frame 13 or the protrusions 15 and replaced. The socket module is further connected by connecting means 17, e.g. cables or hoses, to the test rig space 52 and corresponding devices for power provision and/or signal transmission. In the embodiment, four cables are provided as connecting means 17.

In the embodiment, the second connection module 14 has a substantially square main body with a plug module having a matching plug for each socket of the socket module, which receives the power provided by the first connection module 12 and conducts it through four cables 18 to the test object 60. If the first connection module 12 is configured to transmit signals or pressurized fluids as an alternative to or in addition to transmitting power, the associated plugs and cables of the second connection module 14 are adapted accordingly to enable the transmission to or from the test object 60. The second connection module 14 has at least one engagement portion 16 and at least one support projection 32, In the embodiment, the engagement portion 16 and the support projection 32 are elongated ribs. An engagement portion 16 and a support projection 32 are disposed on the left and right sides of the main body of the second connection module 14, respectively, the engagement portion 16 extending in the direction of gravity and the support projection 32 extending in the normal direction. These elements will be described in more detail later.

Actuator and Engagement Unit

In the embodiment, two actuators 20 are provided symmetrically about the center of the first connection module 12, Therefore, only the left actuator 20 is described below; the right actuator 20 has an analogous configuration.

In the embodiment, the actuator 20 is a pneumatic swing clamp cylinder whose main body is arranged between the two plates of the frame 13 of the first connection module 12. A movable rod projects forward from the main body of the actuator 20, and an engagement unit 22 is attached to the end of the rod. The engagement unit 22 is a cylinder having two concentric circular plates spaced apart from each other. The front circular plate has a recess in the form of a chord. The rear circular plate does not have the recess. The rod and thus the engagement unit 22 are axially displaceable (i.e., in the coupling direction) and are also rotatable about the longitudinal axis of the rod. The actuator 20 and the engagement unit 22 form a coupling mechanism.

An axial end position of the engagement unit 22 corresponds to the extended position of the actuator 20. In or near this end position, the engagement unit 22 is rotatable. In the embodiment, in the end position and without actuation of the actuator 20, the engagement unit 22 is rotated such that the chord of the front circular plate extends in the direction of gravity. This position of the engagement unit 22 is referred to as the alignment position AP. In the alignment position AP, the recesses of the front circular plates of the right and left engagement units 22 face each other, the distance between the chords being slightly greater than the distance between the outer edges of the two engagement portions 16. Thus, the shape of each recess follows the shape of the associated engagement portion 16 with an offset.

An initial actuation of the actuator 20 results in the engagement unit 22 being rotated by 90°, wherein an additional axial movement is possible. This position of the engagement unit 22 is referred to as the locking position VP. A further actuation of the actuator 20 results in the engagement unit 22 being axially displaced to another end position, the rotation of the locking position VP being maintained or retained. This position of the engagement unit 22 is referred to as the coupling position KP. The effects of the various positions AP, VP, KP will be described later with reference to the coupling process.

Storage Device

A spring 24 designed as a compression spring serving as a storage device or energy storage device is provided concentrically around the rod of the actuator 20, The spring 24 abuts the rear circular plate from behind and biases the engagement unit 22 forwards. Accordingly, the spring 24 urges the engagement unit 22 toward the alignment position AP. Thus, the spring 24 as a storage device is also a decoupling mechanism that forms a unit with the coupling mechanism (the actuator 20 and the engagement unit 22) in the embodiment. However, it is also possible to configure the decoupling mechanism (the storage device) different to a spring and to separate it spatially from the coupling mechanism, for example, by providing two magnets centrally in the connection modules 12, 14 and having their same poles facing each other so that the magnets and thus the connection modules 12, 14 repel each other.

Guiding Device

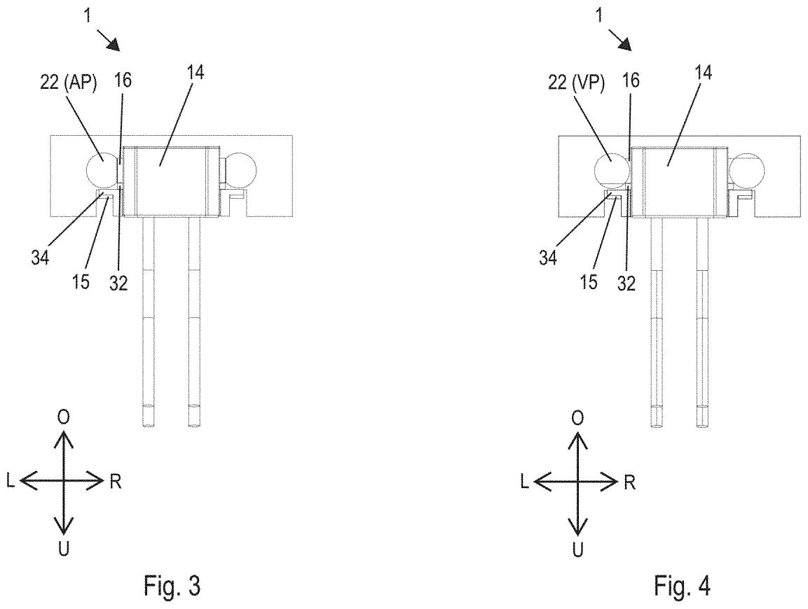

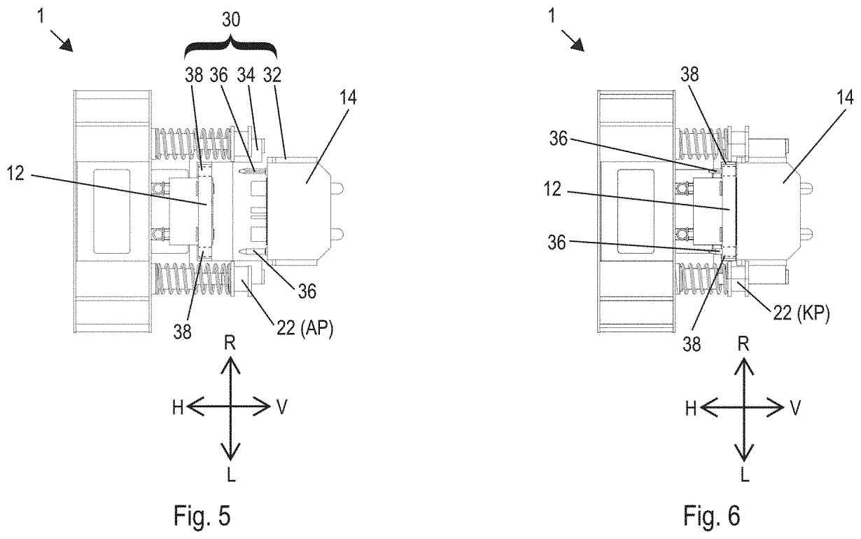

The coupling device 1 further has a guiding device 30. The guiding device 30 in the embodiment includes the two support projections 32 described above paired with two support plates 34 (FIGS. 3 and 4), and two guiding pins 36 paired with two guiding holes 38 (FIGS. 5 and 6). Each of these pairs of components is optional and improves the ease of movement, alignment, and guidance of the second connection module 14. Preferably, at least one element of each pair of components is treated with a lubricant to improve ease of movement, or the ease of movement is provided by providing appropriate material pairings.

The support plates 34 each rest on the protrusions 15 and provide a first surface on which the opposing support projection 32 can rest in the direction of gravity. The first surface is an upper surface in FIGS. 3 and 4; it extends horizontally and serves to guide the second connection module 14 in the horizontal plane. In addition, the support plates 34 each have a second surface that can contact the main body of the second connection module 14 and align it in the left-right direction. The second surface is the surface of the support plate 34, which is vertical in FIGS. 3 and 4 and faces the second connection module 14, Thus, the second surface of the left support plate 34 in FIGS. 3 and 4 can limit the leftward movement of the second connection module 14, and the second surface of the right support plate 34 in FIGS. 3 and 4 can limit the rightward movement of the second connection module 14. The distance between the second surfaces of the support plates 34 and the width of the second connection module 14 are selected with a slight clearance to allow the second connection module 14 to slide with little play. The combination of the first and second surfaces can therefore align the second connection module 14 with the first connection module 12 and provide smooth movement in the coupling direction.

The guiding pins 36 are provided on the plug module of the second connection module 14 and can project with a slight clearance into the guiding holes 38 provided in the socket module opposite the guiding pins 36. In the embodiment, the length of the guiding pins 36 is shorter than the axial distance between the rear circular plate of the engagement unit 22 and the front end of the support plate 34. Thus, there is a position of the second connection module 14 in which the second connection module 14 rests on the support plate 34 without the guiding pins 36 and the guiding holes 38 engaging with each other. This allows alignment using the support plate 34 prior to more precise alignment with the guiding pin 36. In addition, the guiding pins 36 have different cross sections. The upper guiding pin 36 in FIG. 5 has a diamond cross section, while the lower guiding pin 36 in FIG. 5 has a circular cross section. The diamond cross section (reduced full circle) ensures that jamming is reliably prevented due to possible spacing tolerances of the guiding pins, and thus no malfunction can occur.

Coupling Process

With the structure described above, an example of a coupling process results, which is described below with reference to FIGS. 1 to 8.

Initially, the test object 60 is located in the test rig space 52 without being connected. The test object 60 has cables 18 connecting it to the second connection module 14, which has no contact with the first connection module 12. The engagement unit 22 of the first connection module 12 is in the alignment position AP. As an example, this state is shown in FIG. 5.

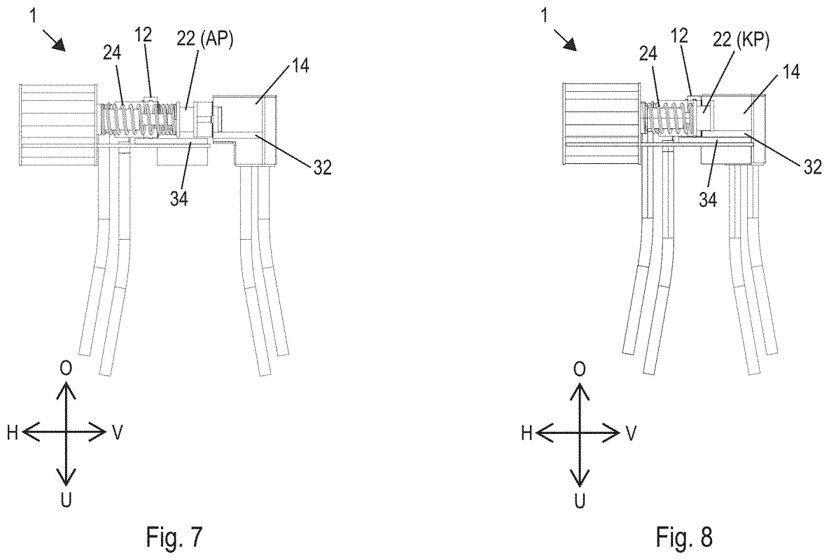

In an initial state for the coupling, the second connection module 14 is provisionally aligned with the first connection module 12 by an assembler, namely to the correct height (FIG. 7) and to the correct position in the of right direction (FIG. 5).

In a first step, the second connection module 14 is placed on the support plates 34 of the first connection module 12 and displaced along the coupling direction. The support projections 32 and the main body of the second connection module 14 cooperate with the support plates 34 and gravity to guide the second connection module 14 in the coupling direction. The front circular plate of the engagement unit 22 has the recess following the shape of the engagement portion 16 with an offset to allow the second connection module 14 to be displaced along the coupling direction starting from the initial state. Thus, the engagement portion 16 of the second connection module 14 passes through the recess before coming into abutment with the rear circular plate of the engagement unit 22. At the end of the movement, the engagement portions 16 of the second connection module 14 abut the rear circular plates of the engagement unit 22. This corresponds to the aligned state in which the second connection module 14 is aligned with the first connection module 12 and is removable from the first connection module 12. The lengths of the plugs of the second connection module 14 are selected such that, in the aligned state, the plugs do not reach the socket module and thus no power transmission can occur. Leading contacts coming into contact before the power transmission is initiated can also be used, for example, for shielding/grounding.

In a next step, an initial actuation of the actuator 20 takes place. The initial actuation results in a rotation of the engagement unit 22, so that the recess of the front circular plate is rotated by 90° (see FIG. 4 compared to FIG. 3) and the engagement unit 22 assumes the locking position VP. Accordingly, the front circular plate now blocks the passage of the engagement portion 16 of the second connection module 14. Thus, the second connection module 14 can no longer be removed from the first connection module 12 by displacing it along the coupling direction. This corresponds to a locked state in which the second connection module 14 is aligned with the first connection module 12, but is not removable from the first connection module 12. Depending on the configuration of the actuator 20, there may be little or no axial movement of the engagement unit 22, so that power transmission can still not occur in the locked state.

In a next step, a continued actuation of the actuator 20 takes place. The continued actuation results in an axial displacement of the engagement unit 22 in the coupling direction and a compression of the spring 24. During the axial displacement of the engagement unit 22, the front circular plate thereby comes into abutment with the front side of the engagement portion 16 of the second connection module 14. As a result, the second connection module 14 is urged by the engagement unit 22 with a coupling force in the coupling direction and is guided by the support plates 34. After part of the distance to be axially traveled by the second connection module 14, the guiding pins 36 also project into the guiding holes 38 to align the plug module of the second connection module 14 even more precisely with the socket module of the first connection module 12 and to improve the guiding accuracy. From about half of the distance to be axially traveled, the plugs of the plug module come into contact with the sockets of the socket module. At the end of the displacement, the engagement unit 22 assumes the coupling position KP, the second connection module 14 has assumed a corresponding coupled position, the plugs and the sockets are in contact, and a power transmission is possible. This corresponds to a coupled state and is shown in FIGS. 2, 6 and 8.

As long as coupling is desired, the actuation of the actuator 20 is maintained in the coupled state. Thus, the coupling force is maintained and the engagement unit 22 is held in the coupling position KP so that the second connection module 14 remains in the coupled state,

Decoupling Process

As the spring 24 has been compressed during the continued actuation of the actuator 20, the spring 24 has stored a part of the energy provided by the actuator 20 by means of the coupling force in the form of potential energy. Accordingly, the spring 24 applies a decoupling force to the engagement unit 22 and urges it forward, that is, from the coupling position KP toward the alignment position AP. In addition, the spring 24 is configured to apply a residual biasing force to the engagement unit 22 in the alignment position AP. This biasing force serves to compensate for sliding friction losses and also accelerates decoupling.

In order to decouple the second connection module 14 from the first connection module 12, the actuation of the actuator 20 is interrupted by interrupting the pressure supply or electrical energy supply. In the embodiment, the actuator 20 is a pneumatic swing clamp cylinder; therefore, the compressed air supply is interrupted for this purpose.

After the interruption, the coupling force, which counteracts the decoupling force and was in equilibrium with the decoupling force in the coupling position KP, is eliminated. Accordingly, the decoupling force now urges the second connection module 14 forward and away from the first connection module 12. Because of the axial movement, the engagement unit 22 therefore reaches the locking position VP and is further axially displaced. The structure of the actuator 20 also causes the rotation of the engagement unit 22, so that at the end of the axial movement the engagement unit 22 is in the alignment position AP, Thus, the relaxation of the spring 24 causes the engagement unit 22 to move from the coupling position KP via the locking position VP to the alignment position AP. By separating the decoupling function (transition from the coupled state to a decoupled state, in this case the locked state) from the locking function (transition from the locked state to the aligned state), that is, by a sequential timing of decoupling and locking, an ejection of the second connection module 14 can be prevented.

Since power transmission is not possible in the alignment position AP and the second connection module 14 is removable from the first connection module 12, the connection modules 12, 14 are thus decoupled,

Coupling System

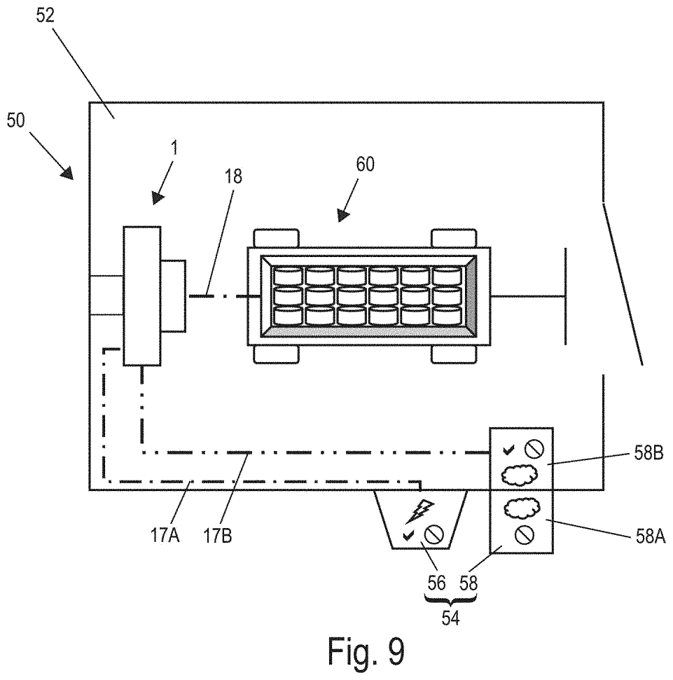

FIG. 9 schematically shows a coupling system 50 in which the coupling device 1 according to the first embodiment is integrated.

The coupling system 50 couples the test rig space 52 to the test object 60. The test object 60 is a battery pack comprising a plurality of battery cells for a battery electric vehicle (BEV) or a plug-in hybrid vehicle (PHEV). The test object 60 is mounted on a handcart, which can be used to drive it into the test rig space 52 through a door and to remove it from the test rig space 52 quickly, for example, in an emergency. The test rig space 52 is used to test the test object 60 under real load conditions, more specifically to simulate charging and discharging operations.

In order to supply electrical power to the test object 60 for these operations, the coupling device 1 is mounted on a wall of the test rig space. The coupling device 1 is connected via cables 17A to a first switch 56 and to a pressure line 17B to a second switch 58. The pressure line 17B provides compressed air to actuate the actuator 20, and the cables 17A provide electrical power to the test object 60, The electrical power is transmitted through the coupling device 1 to cables 18, which conduct it to the test object 60.

The first switch 56 can activate and deactivate the power supply. The second switch 58 can switch the pressure supply to the actuator 20, and thus control the coupling and decoupling by means of controlling the actuator 20. The first switch 56 and the second switch 58 can be operated independently of each other. Therefore, the operations for coupling/decoupling the connection modules 12, 14 and for providing/interrupting the power transmission are independent of each other.

The first switch 56 is located outside the test rig space 52, such as in a control room. The second switch 58 has a part 58A disposed outside the test rig space 52 and a part 58B disposed inside the test rig space 52. The part 58A outside the test rig space 52 can only interrupt the pressure supply. The part 58B inside the test rig space 52 can both interrupt and turn on the pressure supply. Accordingly, only an assembler inside the test rig space 52 can couple the connection modules 12, 14 together, while only a supervisor outside the test rig space 52 can turn on the power supply. Thus, the coupling system is configured so that the locked state can be permanently present, but the coupled state can only be brought about when there are no persons in the test rig space, further improving the assembly safety. Further, the part 58B of the second switch 58 is sufficiently far from the coupling device 1 so that the assembler cannot actuate the part 58B of the second switch 58 while touching the second connection module 14. Thus, the assembler must remove his/her hands from the second connection module 14 in order to actuate the part 58B of the second switch 58 and actuate the actuator 20, thereby reducing the risk of injury. The assembler or any supervisory or security personnel, on the other hand, can decouple the connection modules 12, 14 with any of the parts 58A and 58B at any time, allowing for a quick decoupling and removal of the test object 60 from the test rig space 52 in an emergency.

The two switches 56 and 58 are part of an emergency stop device 54, which is configured such that actuation of the emergency stop device 54 causes both switches 56 and 58 to be interrupted simultaneously. This causes the test rig to shut down while simultaneously decoupling the connector. Individual actuation of each switch 56, 58 also remains independently possible for better control of regular operation and assembly work.

Modifications

In the embodiment, two pneumatic swing clamp cylinders, namely one on each of the left and right sides of the connection modules 12, 14, are provided as actuators 20. Other types of actuators are applicable, and their number can be adjusted according to the spatial situation, the force requirement and the available actuation type.

Although the embodiment has been described with regard to electrical power transmission, the coupling device can alternatively or additionally be used for a pneumatic or hydraulic power transmission. For this purpose, the connection modules 12, 14 are modified by replacing some or all of the cables 17, 18 with hoses and the associated sockets and plugs with hose couplings.

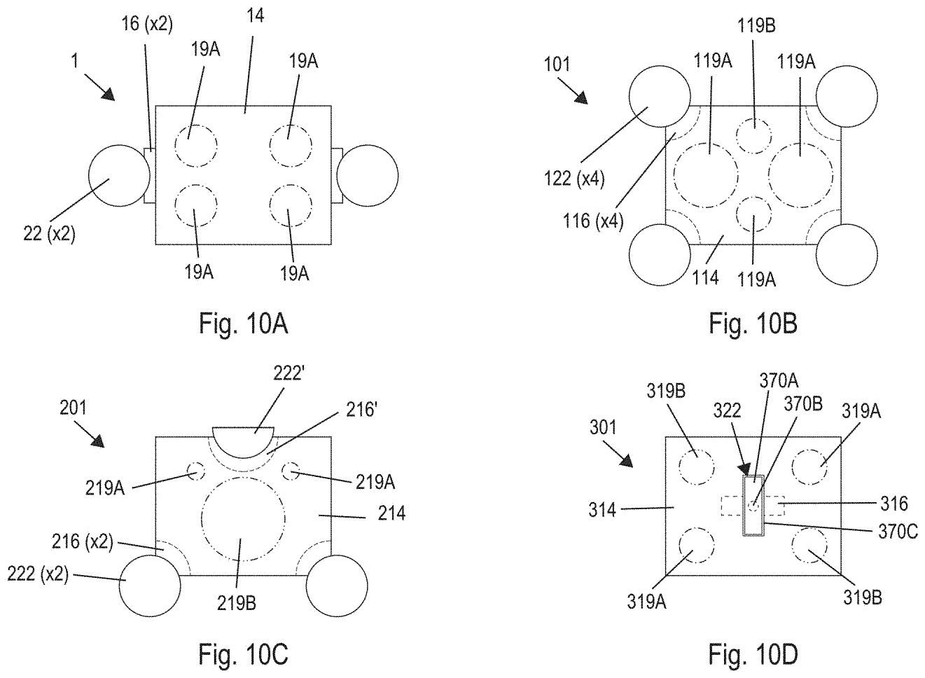

FIG. 10A shows the coupling device 1 of the embodiment in a schematic view when viewed from the front. From a schematic view, the second connection module 14 of the first embodiment has four transmission parts 19, more specifically four electrical transmission parts 19A, corresponding to the sockets and plugs already described. Further, an engagement unit 22 of the first connection module 12 and an engagement portion 16 of the second connection module 14 are provided on the left and right sides, respectively, each engagement portion 16 being formed as a rib. The recess of the engagement unit 22 is not shown.

FIGS. 10B to 10D show schematic and non-exhaustive possible modifications of the coupling device. All modifications deviate from the first embodiment both with respect to the arrangement of the actuators 20 and with respect to the transmission parts provided, wherein both types of deviation are independent of each other and can be combined as desired.

A first modification 101 in FIG. 10B has a configuration in which a total of four engagement units 122 are provided—one at each corner of the second connection module 114. This allows high coupling forces to be implemented, for example for the transmission of high currents. The engagement portions 116 are provided as contact surfaces or contact areas on the front surface of the main body of the second connector 114. Two transmission parts 119A for transmitting electrical power (dashed/dotted line) are provided on the left and right sides. In addition, a smaller sized transmission part 119A for a signal transmission is provided at the bottom and can transmit a measurement signal, for example. Furthermore, a pneumatic transmission part 119B (dashed/double dotted line) is arranged at the top and transmits compressed air, for example for a cleaning nozzle of the test object 60.

A second modification 201 in FIG. 10C has a configuration in which three engagement units are provided—one engagement unit 222 at each of the lower corners and one engagement unit 222′ centrally on the upper edge of the second connection module 214. This allows higher coupling forces to be implemented than in the embodiment. The upper engagement unit 222′ is formed only as a semicircular plate. Thus, less space is required than in the first modification. The engagement portions 216, 216′ are each contact surfaces on the front surface of the second connection module 214. One transmission part 219B transmits hydraulic power, and two electrical transmission parts 219A transmit measurement signals.

A third modification 301 in FIG. 10D has a configuration in which only one engagement unit 322 is provided centrally. This allows the coupling device to be implemented with a single actuator, minimizing cost and space requirements. The engagement unit 322 is formed as a rectangular plate 370A that is rotatable about a central axis 370B and passes through the second connection module 314 through a corresponding recess 370C in the second connection module 314. The engagement portion 316 is a support surface corresponding to the plate 370A on the front side of the second connection module 314. Two transmission parts 319A, 319B for power and compressed air are respectively provided in the four corners of the second connection module 314.

In the embodiment, the initial actuation and the continued actuation of the actuator 20 can be performed independently. Thus, the initial actuation and the continued actuation are separate actuations that allow a separation between the locking position and the coupling position. Alternatively, the two actuations can be performed as one continuous actuation so that locking and coupling can be performed as one uninterrupted operation. Accordingly, the locked state becomes a transitional state, and the second connection module 14 is switchable between an aligned state without power transmission and a coupled state with power transmission. Such a structure enables the use of a simple and cost-effective actuator and reduces the complexity of control required.

The first surfaces of the two support plates 34 in the embodiment are flush, and gravity allows the second connection module 14 to rest and thus holds it in the horizontal plane. Alternatively, a plurality of first surfaces of one or more support plates 34 can guide the second connection module 14 in any plane or along a curved surface.

The embodiment has been described with reference to a normal direction of the wall to which the coupling device 1 is attached, and the normal direction is also the coupling direction. However, the coupling device need not be attached to a wall, but can be arranged, for example, in a freestanding manner on a rack. In addition, the normal direction and/or the coupling direction can be replaced by any other reference direction in order to also enable oblique coupling of the connection modules, depending on the spatial conditions.

### LIST OF REFERENCE SIGNS

1 Coupling device
100 . . . first modification
200 . . . second modification
300 . . . third modification
10 power connector
12 first connection module
13 frame
14 second connection module
15 protrusion
16 engagement portion
17 connecting means
17A cable
17B pressure line
18 cable to test object
19 transmission parts
19A electrical transmission part
19B hydraulic transmission part
20 actuator
22 engagement unit
AP alignment position
KP coupling position
VP locking position
24 storage device
30 guiding device
32 support projection
34 support plate
36 guiding pin
38 guiding hole
50 coupling system
52 test rig space
54 emergency stop device
56 first switch
58 second switch
58A outside
58B inside
test object

1. A coupling device (1) comprising:
a first connection module (12), and
a second connection module (14) releasably connectable to the first connection module (12);
wherein the first connection module (10) and the second connection module (14) form a connector (10),
wherein the coupling device (1) is adapted to:
apply a coupling force that creates a connection between the first connection module (12) and the second connection module (14), and
apply a decoupling force that releases the connection;
wherein
the decoupling force and the coupling force are applied by the first connection module (12) to the second connection module (14),
the decoupling force counteracts the coupling force,
the coupling force is provided by a pneumatic, hydraulic, electric, or electromagnetic actuator (20) provided on the first connection module (12),
the decoupling force is provided by a mechanical, electrostatic, or magnetic storage device (24) capable of receiving, storing, and releasing a portion of the energy generated by the coupling force,
the coupling force is provided by a coupling mechanism,
the decoupling force is provided by a decoupling mechanism, and
the decoupling mechanism forms a unit with the coupling mechanism.

2. The coupling device (1) according to claim 1, wherein
the coupling force is provided by an operating mechanism that is different from the operating mechanism of the decoupling force.

3. The coupling device (1) according to claim 2, wherein
the second connection module (14) has an engagement portion (16),
the first connection module (12) has an engagement unit (22) cooperating with the engagement portion (16) such that the engagement unit (22) is movable between the following positions:
an alignment position (AP) in which the second connection module (14) is aligned with the first connection module (12) and is removable from the first connection module (12), and
a locking position (VP) in which the second connection module (14) is aligned with the first connection module (12) and is prevented from being removed from the first connection module (12).

4. The coupling device (1) according to claim 3, wherein
there is no connection for power transmission in the alignment position (AP) and in the locking position (VP).

5. The coupling device (1) according to claim 4, wherein
the engagement unit (22) is further movable to a coupling position (KP) in which the engagement unit (22) is engaged with the engagement portion (16) and the coupling force is applied to the second connection module (14) by the engagement to move the second connection module (14) to a coupled position and hold it there so that there is a connection for power transmission.

6. The coupling device (1) according to claim 5, wherein
the actuator (20) is an electric or pressure operated swing clamp cylinder comprising a rod having at its distal end the engagement unit (22), and
the engagement unit (22) is rotatable by the swing clamp cylinder between the alignment position (AP) and the locking position (VP) and is axially displaceable between the locking position (VP) and the coupling position (KP).

7. The coupling device (1) according to claim 6, wherein
the storage device (24) is a spring which is relaxed or preloaded in the alignment position (AP) and tensioned in the coupling position (KP).

8. The coupling device (1) according to claim 6, wherein
the storage device (24) and the actuator (20) are adapted so that the energy output of the storage device causes a movement of the engagement unit (22) from the coupling position (KP) via the locking position (VP) to the alignment position (AP).

9. The coupling device (1) according to claim 1, further comprising a guiding device (30) for aligning the second connection module (14) with the first connection module (12).

10. The coupling device (1) according to claim 9, wherein the guiding device (30) comprises:
a support plate (34) provided on the first connection module (12); and
a support projection (32) provided on the second connection module (14);
wherein the support projection (32) rests on the support plate (34) in the alignment position (AP) to align the second connection module (14) with the first connection module (12).

11. The coupling device (1) according to claim 10, wherein the guiding device (30) comprises:
a guiding hole (38) provided on the first connection module (12); and
a guiding pin (36) provided on the second connection module (14);
wherein the guiding hole (38) and the guiding pin (36) are adapted to guide the second connection module (14) between the locking position (VP) and the coupling position (KP) relative to the first connection module (12) so that the aligned connection modules (12, 14) are movable in the coupling direction.

12. The coupling device (1) according to claim 1, wherein the first connection module (12) and the second connection module (14) are adapted to transmit at least one of an electrical power, an electrical signal and a pressurized fluid.

13. A coupling system (50) comprising
a coupling device (1) according to claim 12,
an emergency stop device (54) adapted to interrupt the provision of power to the first connection module (12) and to interrupt the pressure supply or energy supply to the actuator (20) when actuated.

14. The coupling system (50) according to claim 13, further comprising:
a first switch (56) that switches the provision of power to the first connection module (12); and
a second switch (58) that switches the pressure supply or energy supply to the actuator (20).

15. The coupling system (50) according to claim 14, wherein
the coupling device (1) is provided inside a test rig space (52),
the first switch (56) is provided outside the test rig space (52), and
the second switch (58) is provided so as to be operable to turn off the pressure supply or energy supply from outside the test rig space (52) and operable to turn on the pressure supply or energy supply from inside the test rig space (52).
